(19) United States
(12) Patent Application Publication
(10) Pub. No.: US 2003/0147518 A1
(43) Pub. Date: Aug. 7, 2003

(54) METHODS AND APPARATUS TO DELIVER CALLER IDENTIFICATION INFORMATION

(76) Inventors: NANDAKISHORE A. ALBAL, NAPERVILLE, IL (US); JAMES E. GAUGER, OAK PARK, IL (US)

Correspondence Address: MOTOROLA, INC., LAW DEPARTMENT (HDW), 600 NORTH US HIGHWAY 45, AN475, LIBERTYVILLE, IL, 60048, US

(21) Appl. No.: 09/345,555

(22) Filed: Jun. 30, 1999

(51) Int. Cl. H04M 1/64; H04M 1/56

(52) U.S. Cl. 379/207.15; 379/88.19; 379/142.01

(57) ABSTRACT

A system and method of identifying a caller is provided. A subscriber number is inputted into a first communication device to place a call to a subscriber of the communication system. The call is routed through a transport system to a communication node. A determination is made as to whether the number associated with the first communication device matches a stored number in the address book. A name and location associated with the stored number is delivered by the communication node to a second communication device to provide the name and location of the caller to the subscriber.

### FIELD OF THE INVENTION

This invention generally relates to the field of telecommunications and, more particularly, to methods and apparatus to deliver caller identification information.

### BACKGROUND OF THE INVENTION

The current telecommunications environment on the public switched telephone network (PSTN) supports the delivery of the identification of the calling party in the form of caller ID. When the party receiving the call subscribes to a caller ID service and has a suitable subscriber device, the identity of the calling party is provided to the called party. Existing subscriber devices typically display the calling party's telephone number. The subscriber devices may also provide the name of the calling party. The called party may employ additional devices such as, for example, a caller identification display and/or additional workstation software, to use the identification data of the calling party (provided by the carrier) for various applications. These applications may include, for example, logging calls, providing the calling party's picture, presenting the history of past interactions, etc. The calling party's identification may also be displayed on a personal computer or read to the subscriber using a text-to-speech unit of the device. However, if the calling party disables the delivery of the caller identification, the receiving party will not receive the calling party's identification even if the receiving party has subscribed to the caller identification feature.

Certain subscriber devices use the delivered caller identification data to determine the name of the calling party based on an address book stored on a personal computer (PC) at the destination. An example of such a product is Connect-ID, which relies on the delivery of the caller ID by the network and an address book on the PC. Another example of such a product is Intellect, which is similar to the Connect-ID product described above. Another example of a subscriber device is the Nokia communicator handset for use in the ESTI DSC1800 spectrum. This product displays the caller identification data (telephone number and/or name) and includes an address book. Finally, the Talking Caller ID product uses text-to-speech (TTS) technology to convert to calling party's identification into speech. In particular, this product uses the caller identification telephone number as a key to look up a contact in an address book and delivers the information to a TTS unit.

The disadvantage of conventional caller identification systems is that the calling party may block the delivery of his or her identification data. As a result, conventional caller identification services can be rendered inoperative if the calling party elects to place a block on the delivery of his or her identification data. Moreover, conventional caller identification systems require that the called party subscribe to the caller identification feature and purchase a proper subscriber device, which results in increased cost to the receiving party. Finally, conventional subscriber devices are typically only able to provide a limited amount of information about the caller.

### BRIEF DESCRIPTION OF THE DRAWINGS

FIG. 1 is a block diagram of an embodiment of a communication system in accordance with the present invention;

FIG. 2 is an exemplary block diagram of another embodiment of a communication system in accordance with the present invention;

FIG. 3 is an exemplary block diagram of an address book;

FIG. 4 is a flowchart that illustrates one embodiment of a routine to provide caller identification information to a subscriber in accordance with the present invention;

FIG. 5 is a flowchart that illustrates another embodiment of a routine to provide caller identification information to a subscriber in accordance with the present invention;

FIG. 6 is a flowchart that illustrates another embodiment of a routine to provide caller identification information to a subscriber in accordance with the present invention;

FIG. 7 is a flowchart that illustrates another embodiment of a routine to provide caller identification information to a subscriber in accordance with the present invention;

FIG. 8 is a flowchart that illustrates an embodiment of a routine to provide caller identification information to a party called by a subscriber in accordance with the present invention; and

FIG. 9 is an exemplary block diagram of another embodiment of a communication system in accordance with the present invention.

### DETAILED DESCRIPTION OF THE PRESENTLY PREFERRED EMBODIMENTS

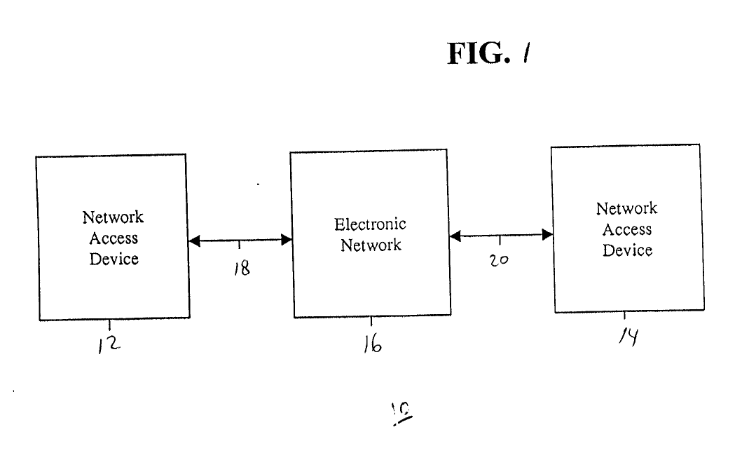

FIG. 1 is a block diagram that illustrates an embodiment of a communication system 10. The communication system 10 generally includes one or more network access apparatus or communication devices 12 and 14 (two being shown) and an electronic network 16.

The communication system 10 can provide various services and capabilities to cellular subscribers, wireline subscribers, paging subscribers, satellite subscribers, mobile or portable phone subscribers, trunked radio subscribers, computer network subscribers (i.e., internet subscribers, intranet subscribers, etc.), wireless data subscribers, branch office users, and the like. For example, the communication system can deliver caller identification to a called party as further described below. The communication system 10 can also provide speech recognition, incoming call authorization, call routing, text-to-speech capabilities, touch-tone recognition, content information, speech-to-text capabilities, messaging services, call screening, interactive voice applications, voice mail, voice dialing, etc.

The network access apparatus 12 and 14 of the communication system 10 can be utilized by the subscribers or users to access and/or connect with the electronic network 16. The network access apparatus 12 and 14 of the system can have a variety of forms, including but not limited to, a telephone, a mobile phone, an office phone, a work phone, a home phone, a pay phone, a paging unit, a radio unit, a wireless data device, a web phone, a portable or wireless phone, a personal information manager (PIM), a personal digital assistant (PDA) having an address (i.e., a phone number, an email address, etc.), a general purpose computer, a network television, an Internet television, an Internet telephone, a portable wireless device, a workstation, or any other suitable communication device. It is contemplated that the network access apparatus can be integrated with the electronic network.

The electronic network 16 is communicatively coupled to the network access apparatus 12 via a line 18, and the electronic network 16 is communicatively coupled to the network access apparatus 14 via a line 20. The lines 18 and 20 can include, but are not limited to, a telephone line or link, an ISDN line, a coaxial line, a cable television line, a fiber optic line, a LAN, a WAN, a computer network line, a digital subscriber line, a dedicated line, a pay or lease line, a virtual private network, an internet, or the like. Alternatively, the network access apparatus 12 and 14 can wirelessly communicate with the electronic network. For example, the electronic network 14 can communicate with the network access apparatus 12 and 14 by a satellite communication system or a wireless communication system.

The electronic network 16 can receive incoming transmissions or data (i.e., paging and voice transmissions, e-mails, faxes, etc.) from the network access apparatus 12 and can route the incoming transmissions to network access apparatus 14 or back to the network access apparatus 12. The electronic network 16 can include, but is not limited to, an intranet, an extranet, a local area network, a telephone network, (i.e., a public switched telephone network), a cellular telephone network, a personal communication system (PCS) network, a television network (i.e., a cable television system), a paging network (i.e., a local paging network), a regional paging network, a national or a global paging network, an e-mail system, a wireless data network (i.e., a satellite data network or a local wireless data network), a wireless LAN, a wireless local loop (i.e., an LMDS), a VOIP network and/or a telecommunication node. The electronic network 16 can also include an open, wide area network such as the Internet, the World Wide Web (WWW), and/or an on-line service.

The electronic network 16 can provide various calling capabilities to a user. For example, the network can place a call to a particular contact at a selected location or device in response to speech commands or DTMF tones from the user (i.e., “call Bob at home”, “call Ann Jones at work”, or “dial Bill on mobile phone”). If the user does not specify the location of the party or the device to call, the network can automatically prompt the user for the location of the party and/or the device (i.e., “the valid locations for Bob are home, work, and mobile phone”). Alternatively, the user can program the network to automatically call a default or designated number of the party. The electronic network can route incoming calls to a party and provide the caller identification information (i.e., name, number, and/or location) of the calling party to the called party. The network can provide the caller information via a telephone, paging unit, or any other suitable subscriber device.

The electronic network also preferably includes an address book or personal file that stores names of a subscriber's contacts along with their addresses and phone numbers as further described below. When a subscriber accesses the electronic network through the network access device, the electronic network can access the information about one or more of the subscriber's contacts and can provide the information (i.e., addresses, etc.) to the subscriber. After the network has accessed the name of the party in the address book, the user can call the party by using voice commands (i.e., “call Bob”). The network can also access a subscriber database that stores the phone number of the subscriber to determine the subscriber's information (i.e., name, number, and/or location) based upon the subscriber's number. The network can provide the name, number, and/or location of the subscriber to a called party through the use of caller ID.

When a caller is calling a phone number assigned to a subscriber, the network can access the subscriber's address book to determine the caller's identification information (i.e., name, number, and location) based upon the caller's number and can provide the caller's information to the subscriber through the use of caller ID. If the caller cannot be found in the address book, the electronic network can search other databases (i.e., reverse look-up directories) to determine the information about the caller and provide the information to the subscriber. The caller's information can be provided to the subscriber as text or speech. The caller's information can also be delivered to a different communication device (i.e., paging unit) of the subscriber than the call was place to.

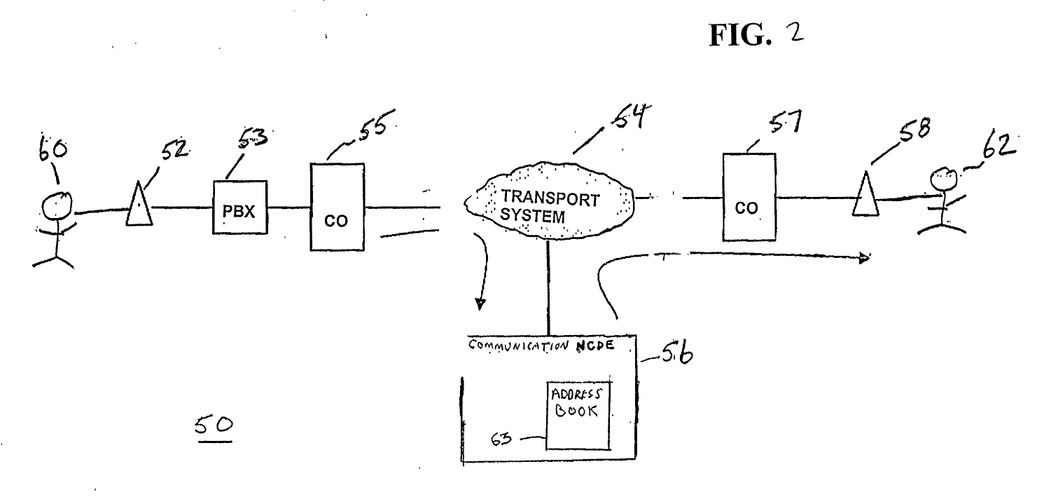

FIG. 2 illustrates another embodiment of a communication system 50 that provides caller identification services and/or features. The system 50 can deliver or transmit caller identification information (i.e., the name, number, and/or location) of the calling party 60 to the called party 62. The caller identification information can be provided in a variety of forms such as, for example, spoken words, short message service (SMS), pages, and cellular data. The delivery of such information may not be subject to blocks placed by the caller 60. When a calling party 60 calls a called party 62, the system can allow the called party 62 to control the disposition of the incoming call. Further, the called party 62 may not need a separate caller identification enabled device to receive the caller identification information.

As shown in FIG. 2, the system 50 generally includes a first communication device 52 having an associated number, a transport system 54, a communication node 56 including an address book 63, and a second communication device 58. The first communication device 52 is preferably operatively connected to the transport system 54 through a conventional private branch exchange (PBX) 53 and a central office (CO) 55 of the carrier. Similarly, the second communication device 58 is preferably operatively connected to the transport system 54 through the central office 57 of the carrier. The transport system 54 is operatively connected to the communication node 56. The transport system 54 routes calls from the first communication device 52 to the communication node 56 and from the node to the second communications device 58. The transport system 54 can be a Public Switched Telephone Network (PSTN). Alternatively, the transport system 54 may preferably be a cellular network or voice over internet protocol (VOIP) network. It will be recognized that the communication node can be integrated with the transport system.

The first communication device 52 can be any electronic device capable of sending and receiving electronic signals such as, for example, a telephone, a cellular phone, a paging unit, a computer with VOIP capability, or any other suitable communication device. Similarly, the second communication device 58 may preferably be any electronic device capable of sending and receiving electronic signals such as, for example, a telephone, a cellular phone, a paging unit, a computer with VOIP capability, or any other suitable communication device.

In one embodiment, each subscriber has an assigned subscriber number. When a caller 60 places a call to a called party or subscriber 62, the communication node 56 determines the number of the caller through the use of caller line identification (CLI) and/or automatic number identification (ANI). It is also contemplated that the node can determine the caller's number and/or name in response to speech commands or DTMF tones from the calling party. The node then searches a contact list for the subscriber to find a contact with the telephone number of the calling party. The communication node 56 preferably determines the name and number of the calling party by accessing an address book 63 of the subscriber 62. Once the node finds a match between the caller's telephone number and a stored number in the subscriber's contact list, the communication node 56 determines the name and number associated with the caller's phone number. After the node has determined the name and/or number of the caller in the subscriber's address book, the node establishes a connection between the node 60 and the subscriber.

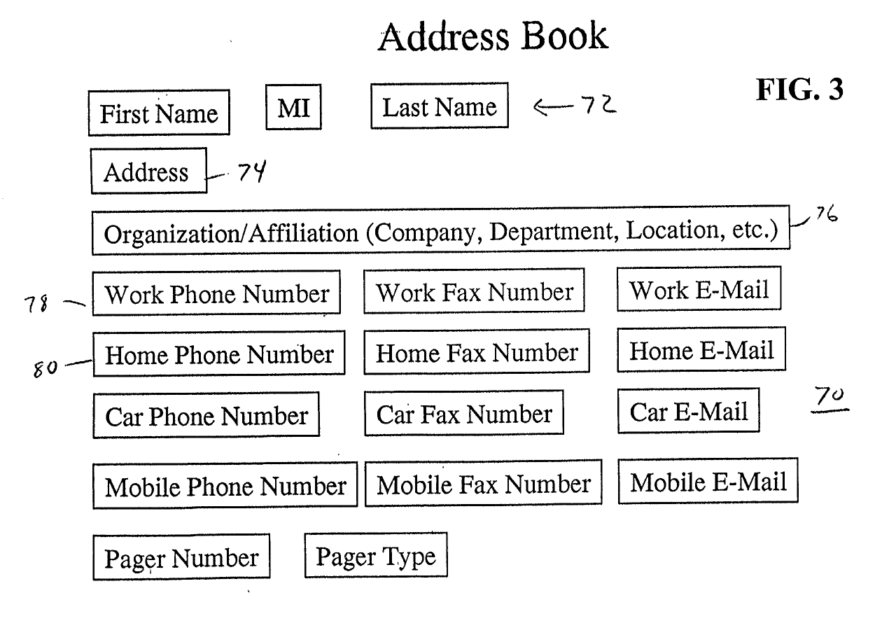

After the node establishes a connection with the communication device of the subscriber, the communication node 56 delivers the caller ID information to the second communication device 58 to provide the subscriber 62 with the name, number, and/or location of the caller 60. If the contact is not in the subscriber's address book, the node can search remote databases, such as reverse look up databases to determine information about the caller. The subscriber then has the option of accepting the call, asking the system to place the caller in hold, or sending the call to voice mail. If the node determines that the subscriber will accept the call from the caller, the node establishes a connection between the caller and the subscriber. The address book 63 is preferably a centralized database within the communication node 56 that contains information on any number of potential callers and/or subscribers. An example of an address book 70 is illustrated in FIG. 3. The address book 70 preferably includes a list of contacts for a subscriber. FIG. 3 illustrates the information that the address book can store for a single contact of the subscriber. For example, the address book can store the contact's name 72, address 74, organization/affiliation 76, work phone number 78, home phone number 80, etc. The address book can also include a subscriber's profile (not shown). The subscriber profile can include the subscriber's various numbers (i.e., work phone, home phone, cell phone, pager number, etc.), the subscriber's schedule, and at which number a contact can reach the subscriber. For example, the subscriber can set his or her availability to indicated that he is accepting calls, he is not accepting calls, or he is accepting only certain calls. The subscriber can also select a phone or location in which the subscriber can be reached (i.e., work, home, mobile, etc.).

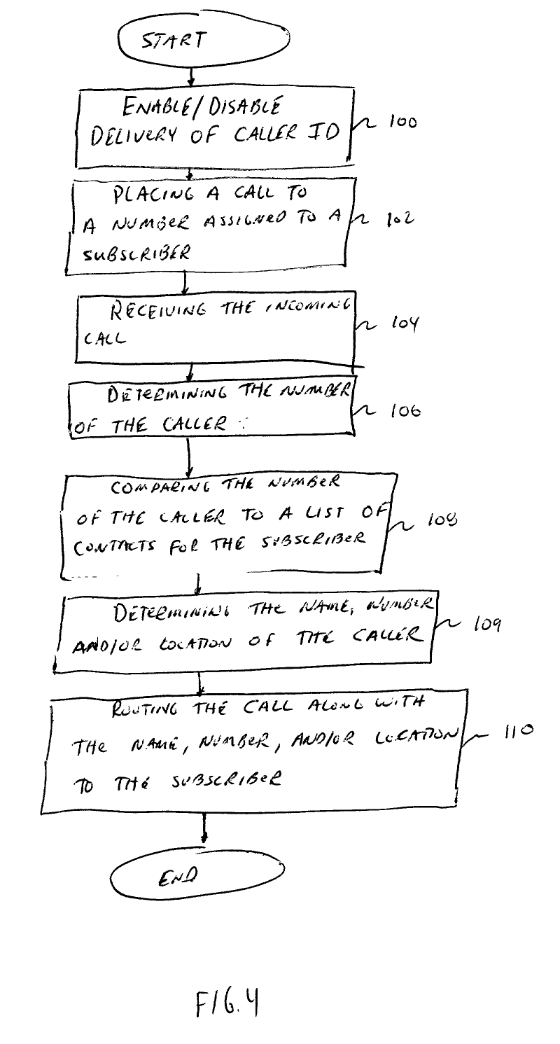

FIG. 4 is a flowchart that illustrates one embodiment a routine to provide caller identification information to a subscriber. The routine can be implemented by the communication systems 10 and 50 as described above. For simplicity, reference will only be made to the communication system 50 shown in FIG. 2 when describing the routine. At block 100, the caller may either enable or disable the delivery of their caller identification. At block 102, the caller places a call to a number assigned to the subscriber. The call is routed to the communication node 56 and the node receives the incoming call at block 104. At block 106, the node determines the number of the caller through the use of caller ID or ANI. Since the node can read the ANI, the node can determine the number of the caller even if the caller places a block on the delivery of the caller identification. As a result, the communication node can bypass the caller identification block and still provide the subscriber with the identity of the caller.

At block 108, the communication node 56 compares the number of the caller with a contact list for the subscriber. The contact list is preferably stored in an address book of the subscriber as described above. It is also contemplated that the communication node may access any number of remote databases (i.e., a phone book, reverse look-up databases, etc.) to determine the name and location of the caller. Once the node finds the caller's number in the contact list or remote databases, the node determines the name, number, and location of the caller at block 109. The communication node then routes the incoming call to the subscriber along with the name, number, and/or location of the caller at block 110. If the node cannot find the caller's number in the subscriber's contact list, the node routes the incoming call along with the phone number of the caller.

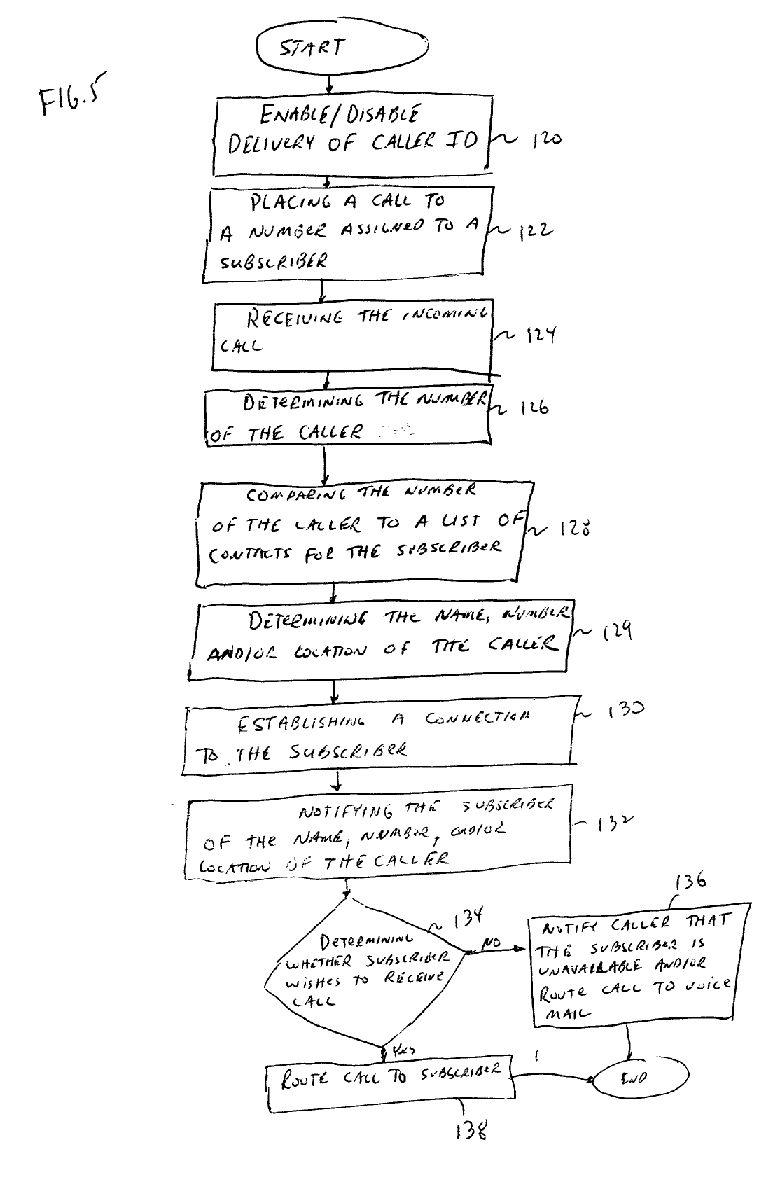

FIG. 5 shows another flow diagram of a routine to provide caller information to a subscriber. Steps 120-129 of the routine shown in FIG. 5 correspond, in many respects, in operation and function to the previously described steps 100-109 of the routine of FIG. 4. The steps 120-129 of the routine of FIG. 5 which correspond to the steps 100-109 of the routine of FIG. 4 are designated by like reference numbers in the one-hundred twenty series. Accordingly, further description of the steps 120-129 of the routine of FIG. 5 are unnecessary for a complete understanding of the present invention.

After the node determines the name, number, and/or location of the caller at block 129, the node establishes a connection with the subscriber at block 130. This may be accomplished by placing a call from the node to the subscriber or paging the subscriber. At block 132, the node delivers the caller's name, number, and/or location to the subscriber. This may be accomplished either in-band or out-of-band. For example, audible signals generated via a text-to-speech device and/or pre-stored audio files that identify the name and location of the caller may preferably be sent in-band after the channel is established between communication node and the subscriber's device (i.e., a landline telephone, a cellular phone, etc.). In this scenario, the subscriber is only in communication with the communication node, but not with the caller. As a result, the caller is unaware of the dialog between the communication node and the subscriber. For example, after the subscriber answers a call from the node, the following announcement may be played to the subscriber: “Ann Jones is calling from her car. Do you wish to receive this call?” Alternatively, a short message service (SMS) may be delivered to the subscriber's communication device . Finally, other out-of-band signaling may be delivered to the second communication device that has the capability of displaying the name, number, and/or location of the caller. If the node cannot find the caller's number in the subscriber's contact list, the node routes the incoming call along with the phone number of the caller.

After notifying the subscriber of the caller's information, the node determines whether to connect the call to the subscriber in response to in-band voice commands or DTMF tones or out of band signals from the subscriber at block 134. If the subscriber decides not to answer the call, the subscriber may instruct the communication node to place the call on hold or send the call into voicemail at block 136. If the subscriber decides to answer the call, the subscriber can instruct the communication node to complete the call from the caller to the subscriber's communication device at block 138. Alternatively, the subscriber may instruct the communication node to play a pre-recorded message or announcement or disconnect the call.

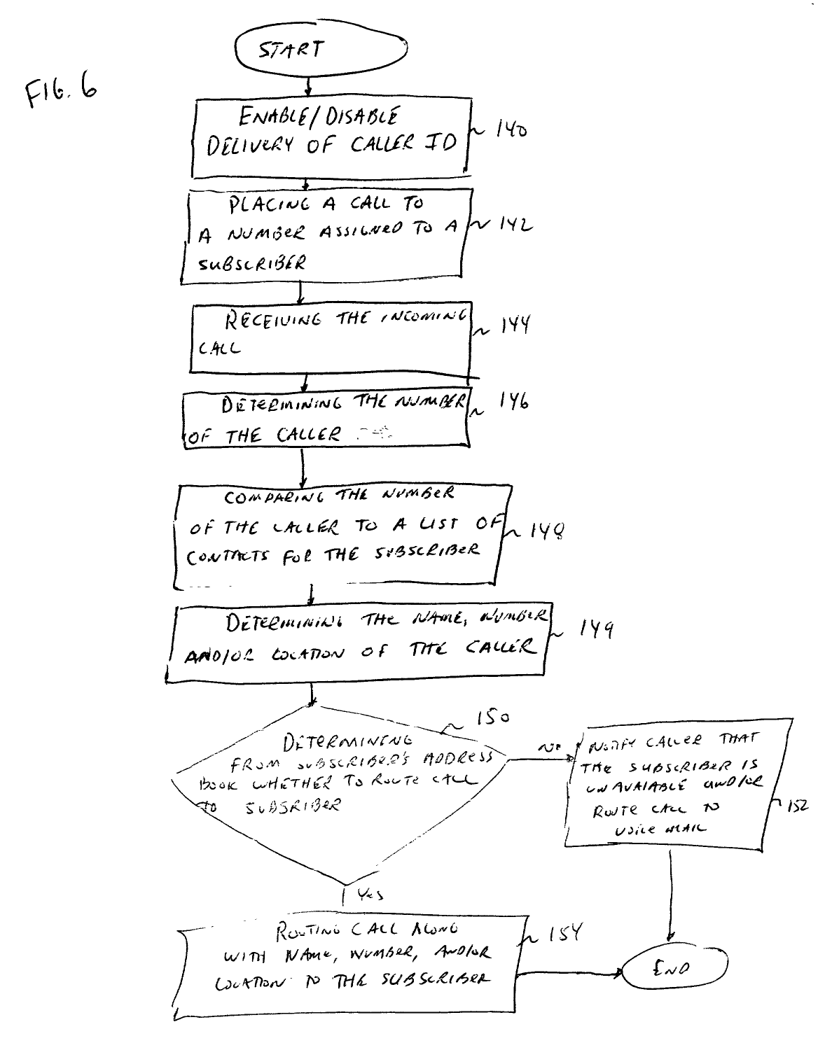

FIG. 6 shows another flow diagram of a routine carried out by the node to provide caller information to a subscriber. Steps 140-149 of the routine shown in FIG. 6 correspond, in many respects, in operation and function to the previously described steps 100-109 of the routine of FIG. 4. The steps 140-149 of the routine of FIG. 6 which correspond to the steps 100-109 of the routine of FIG. 4 are designated by like reference numbers in the one-hundred forty series. Accordingly, further description of the steps 140-149 of the routine of FIG. 6 are unnecessary for a complete understanding of the present invention.

After the node determines the name, number, and/or location of the caller at block 149, the node determines from the subscriber's address book whether to route the call to the subscriber at block 150. If the subscriber has indicated in his/her profile that he/she is unavailable, the node notifies the caller that the subscriber is unavailable and/or routes the call to voice mail at block 152. If the subscriber is available, the node routes the call along with the name, number, and/or location to the subscriber at block 154. The subscriber can then determine the identity of the caller based upon the caller's information and decide whether to answer the call. If the node cannot find the caller's number in the subscriber's contact list, the node routes the incoming call along with the phone number of the caller.

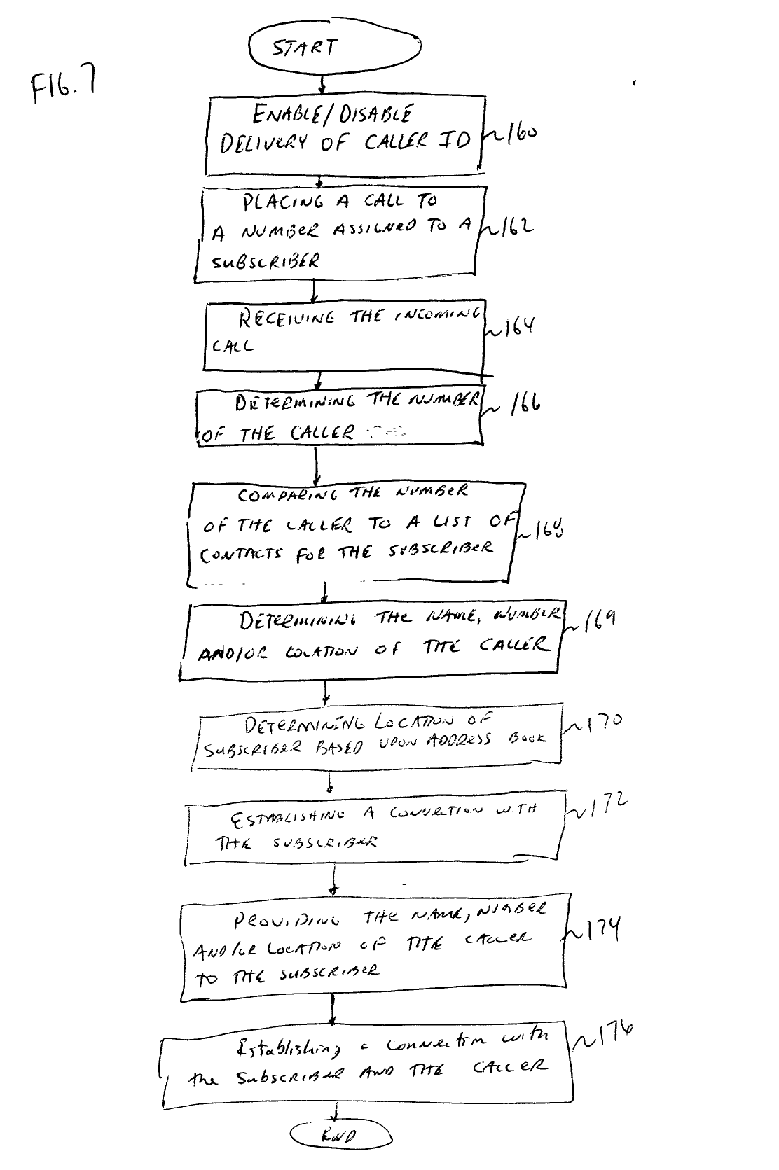

FIG. 7 shows another flow diagram of a routine carried out by the node to provide caller information to a subscriber. Steps 160-169 of the routine shown in FIG. 7 correspond, in many respects, in operation and function to the previously described steps 100-109 of the routine of FIG. 4. The steps 160-169 of the routine of FIG. 7 which correspond to the steps 100-109 of the routine of FIG. 4 are designated by like reference numbers in the one hundred sixty series. Accordingly, further description of the steps 160-169 of the routine of FIG. 7 are unnecessary for a complete understanding of the present invention.

After the node determines the name, number, and/or location of the caller at block 169, the node determines the location of the subscriber or the device in which the subscriber has selected to receives calls at block 170. At block 172, the node establishes a connection with the subscriber and provides the name, number, and/or location of the caller to the subscriber at block 174. If the subscriber indicates that he or she will receive the call via DTMF tones, voice commands, a page, out-of-band signaling, etc., the node establishes a connection with the subscriber and the caller at block 176. If the subscriber indicates that he or she is unavailable, the node can play a pre-recorded message to the caller and/or route the call to voice mail. If the node cannot find the caller's number in the subscriber's contact list, the node routes the incoming call along with the phone number of the caller.

One advantage of the present system is that it provides the caller's name, number, and location to the subscriber without connecting the call to the subscriber. Also, the node allows the subscriber to control the disposition of the call. Moreover, the system can bypasses any caller identification blocks placed by the caller 60. In addition, the party called need not have a caller identification enabled device to have access to the caller identification features. This results in a substantial cost savings for the party who desires the caller identification features. Finally, the system provides a network based caller identification function for both PSTN, cellular networks, satellite, VOIP networks, etc.

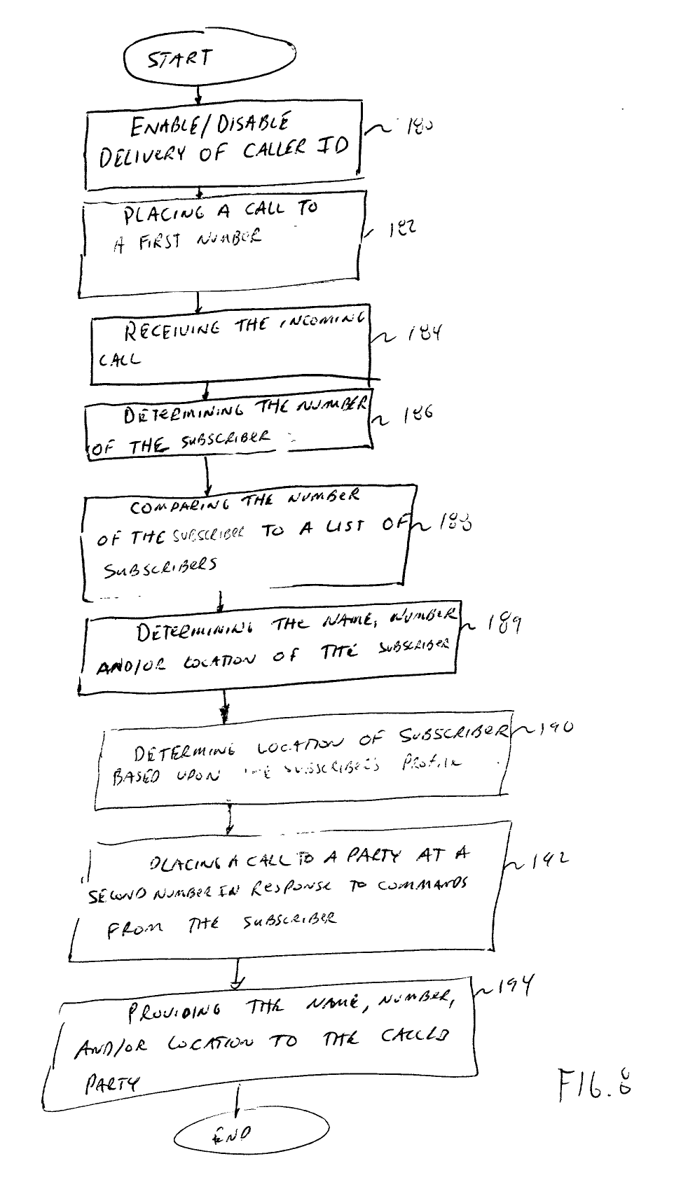

FIG. 8 shows a flow diagram of another routine to provide the subscriber's caller ID information to a called party. At block 180, the subscriber may either enable or disable the delivery of their caller identification. If the subscriber disables the delivery of the caller identification, no caller identification information will be provided to the called party.

At block 182, the subscriber places a call to a first number. The call is routed to the communication node and the node receives the incoming call at block 184. At block 186, the node determines the number of the subscriber through the use of caller ID or ANI.

At block 188, the communication node compares the number of the subscriber with a stored list of subscribers. Once the node finds the subscriber's number in the subscriber list, the node determines the name, number, and/or location of the subscriber at block 189. At block 190, the node can determine the location of the subscriber based upon the subscriber's profile.

The node then places a call to a second number in response to voice commands or DTMF tones at block 192. For example, the subscriber can say “Call Bob at home”, and the node will access the subscriber's address book to determine Bob's home number and place a call to Bob at home. The communication node then routes the call to the called party along with the name, number, and/or location of the subscriber at block 194.

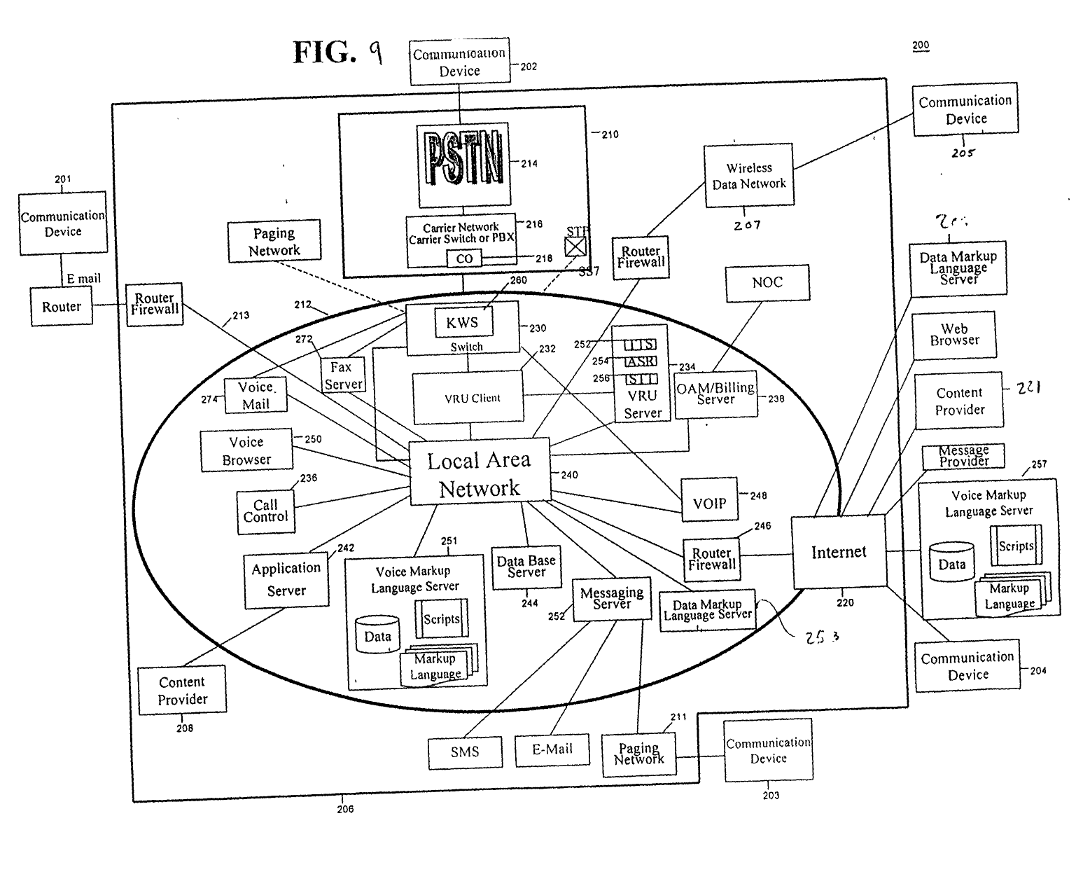

Referring now to FIG. 9, an exemplary block diagram of another embodiment of a communication system 200 is illustrated. The system can carry out the flow diagrams shown in FIGS. 3-8 in order to provide caller ID information to a called party. The system 200 generally includes one or more communication devices or network access apparatus 201, 202, 203, 204, and 205 (five being shown), an electronic network 206, and one or more information sources (i.e., content providers 208 and 221 (two being shown) and data and voice markup language servers 209, 251, 253, 257).

As shown in FIG. 9, the electronic network 206 of the system 200 includes a telecommunication network 210 and a communication node 212. The telecommunication network 210 is preferably connected to the communication node 212 via a high-speed data link, such as, a T1 telephone line, a local area network (LAN), a wide area network (WAN) or a VOIP network. The telecommunication network 210 preferably includes a public switched network (PSTN) 214 and a carrier network 216. The telecommunication network 210 can also include international or local exchange networks, a cable television network, interexchange carrier networks (IXC) or long distance carrier networks, cellular networks (i.e., mobile switching centers (MSC)), PBXs, satellite systems, wireless data networks, and other switching centers such as conventional or trunked radio systems (not shown), etc. The electronic network can also include additional telecommunication networks, such as a wireless data network 207 or any of the networks or systems described above.

The PSTN 214 of the telecommunication network 210 can include various types of communication equipment or apparatus, such as ATM networks, Fiber Distributed data networks (FDDI), T1 lines, cable television networks, VOIP networks and the like. The carrier network 216 of the telecommunication network 210 generally includes a telephone switching system or central office 218. It will be recognized that the carrier network 216 can be any suitable system that can route calls to the communication node 212, and the telephone switching system 218 can be any suitable wireline or wireless switching system.

The communication node 212 the system 200 is preferably configured to receive and process incoming calls from the carrier network 216 and the Internet 220, such as the WWW. The communication node can receive and process pages from the paging network 211 and can also receive and process messages (i.e., e-mails) from the LAN, WAN, wireless data network or e-mail connection 213.

When a user dials into the electronic network 206 from the communication device 202, the carrier network 216 routes the incoming call from the PSTN 214 to the communication node 212 over one or more telephone lines or trunks. The incoming calls preferably enters the carrier network 216 through one or more “888” or “800” INWATS trunk lines, local exchange trunk lines, or long distance trunk lines. It is also contemplated that the incoming calls can be received from a cable network, a cellular system, VOIP network or any other suitable system.

The communication node 212 answers the incoming call from the carrier network 216 and retrieves an appropriate announcement (i.e., a welcome greeting) from a database, server, or browser. The node 212 then plays the announcement to the caller. In response to audio inputs from the user, the communication node 212 retrieves information from a destination or database of one or more of the information sources, such as the content providers 208 and 221 or the voice or data markup language servers 209, 251, 253 and 257. After the communication node 212 receives the information, the communication node provides a response to the user based upon the retrieved information.

The node 212 can provide various dialog voice personalities (i.e., a female voice, a male voice, etc.) and can implement various grammars (i.e., vocabulary) to detect and respond to the audio inputs from the user. In addition, the communication node can automatically select various speech recognition models (i.e., an English model, a Spanish model, an English accent model, etc.) based upon a user profile, the user's communication device, and/or the user's speech patterns. The communication node 212 can also allow the user to select a particular speech recognition model.

When a user accesses the electronic network 206 from a communication device registered with the system (i.e., a user's home phone, work phone, cellular phone, etc.), the communication node 212 can by-pass a user screening option and automatically identify the user (or the type of the user's communication device) through the use of automatic number identification (ANI) or caller line identification (CLI). After the communication node verifies the call, the node provides a greeting to the user (i.e., “Hi, this is your personal agent, Maya. Welcome Bob. How may I help you?”). The communication node then enters into a dialogue with the user, and the user can select a variety of information offered by the communication node.

When the user accesses the electronic network 206 from a communication device not registered with the system (i.e., a payphone, a phone of a non-subscriber, etc.), the node answers the call and prompts the user to enter his or her name and/or a personal identification number (PIN) using speech commands or DTMF tones. The node can also utilize speaker verification to identify a particular speech pattern of the user. If the node authorizes the user to access the system, the node provides a personal greeting to the user (i.e., “Hi, this is your personal agent, Maya. Welcome Ann. How may I help you?”). The node then enters into a dialogue with the user, and the user can select various information offered by the node. If the name and/or PIN Number of the user cannot be recognized or verified by the node, the user will be routed to a customer service representative.

Once the user has accessed the system, the user may implement a wide variety of services and features by using voice commands, such as, for example, voice dialing, voice paging, facsimiles, caller announcements, voice mails, reminders, call forwarding, call recording, content information (i.e. newspapers, etc.), read e-mail, read calendars, read “to-do” lists, banking, v-commerce, e-commerce, etc. The system can place outbound calls and pages to business and personal parties or contacts (i.e., friends, clients, business associates, family members, etc.) in response to DTMF tones, out-of-band signaling, or speech commands. The calls can be routed through a telephone or electronic network to the selected party and the pages can be sent to a selected party via a paging system. The system can also receive calls routed through a telephone or electronic network.

As shown in FIG. 9, the communication node 212 preferably includes a telephone switch 230, a voice or audio recognition (VRU) client 232, a voice recognition (VRU) server 234, a controller or call control unit 236, an Operation and Maintenance Office (OAM) or a billing server unit 238, a local area network (LAN) 240, an application server unit 242, a database server unit 244, a gateway server or router firewall server 246, a voice over internet protocol (VOIP) unit 248, a voice browser 250, a voice markup language server 251, a messaging server 252, and a data markup language server 253. Although the communication node 212 is shown as being constructed with various types of independent and separate units or devices, the communication node 212 can be implemented by one or more integrated circuits, microprocessors, microcontrollers, or computers which may be programmed to execute the operations or functions equivalent to those performed by the device or units shown. It will also be recognized that the communication node 212 can be carried out in the form of hardware components and circuit designs, software or computer programming, or a combination thereof.

The communication node 212 can be located in various geographic locations throughout the world or the United States (i.e., Chicago, Ill.). The communication node 212 can be operated by one or more carriers (i.e., Sprint PCS, Qwest Communications, MCI, etc.) or independent service providers, such as, for example, Motorola, Inc.

The communication node 212 can be co-located or integrated with the carrier network 216 (i.e., an integral part of the network) or can be located at a remote site from the carrier network 216. It is also contemplated that the communication node 212 may be integrated into a communication device, such as, a wireline or wireless phone, a radio device, a personal computer, a PDA, a PIM, etc. In this arrangement, the communication device can be programmed to connect or link directly into an information source.

The communication node 212 can also be configured as a standalone system to allow users to dial directly into the communication node via a toll free number or a direct access number. In addition, the communication node 212 may comprise a telephony switch (i.e., a PBX or Centrix unit), an enterprise network, or a local area network. In this configuration, the system 200 can be implemented to automatically connect a user to the communication node 212 when the user picks a communication device, such as, the phone.

When the telephone switch 230 of the communication node 212 receives an incoming call from the carrier network 216, the call control unit 236 sets up a connection in the switch 230 to the VRU client 232. The communication node 212 then enters into a dialog with the user regarding various services and functions. The VRU client 232 preferably generates pre-recorded voice announcements and/or messages to prompt the user to provide inputs to the communication node using speech commands or DTMF tones. In response to the inputs from the user, the node 212 retrieves information from a destination of one of the information sources and provides outputs to the user based upon the information.

The telephone switch 230 of the telecommunication node 212 is preferably connected to the VRU client 232, the VOIP unit 248, and the LAN 240. The telephone switch 230 receives incoming calls from the carrier switch 216. The telephone switch 230 also receives incoming calls from the communication device 204 routed over the Internet 220 via the VOIP unit 248. The switch 230 also receives messages and pages from the communication devices 201 and 203, respectively. The telephone switch 230 is preferably a digital cross-connect switch, Model No. LNX, available from Excel Switching Corporation, 255 Independence Drive, Hyannis, Mass. 02601. It will be recognized that the telephone switch 230 can be any suitable telephone switch.

The VRU client 232 of the communication node 212 is preferably connected to the VRU server 234 and the LAN 240. The VRU client 232 processes speech communications, DTMF tones, pages, and messages (i.e., e-mails) from the user. Upon receiving speech communications from the user, the VRU client 232 routes the speech communications to the VRU server 234. When the VRU client 232 detects DTMF tones, the VRU client 232 sends a command to the call control unit 236. It will be recognized that the VRU client 232 can be integrated with the VRU server.

The VRU client 232 preferably comprises a computer, such as, a Windows NT compatible computer with hardware capable of connecting individual telephone lines directly to the switch 230 or carrier network 216. The VRU client preferably includes a microprocessor, random access memory, read-only memory, a T1 or ISDN interface board, and one or more voice communication processing board (not shown). The voice communication processing boards of the VRU client 232 are preferably Dialogic boards, Model No. Antares, available from Dialogic Corporation, 1515 Route 10, Parsippany, N.J. 07054. The voice communication boards may include a voice recognition engine having a vocabulary for detecting a speech pattern (i.e., a key word or phrase). The voice recognition engine is preferably a RecServer software package, available from Nuance Communications, 1380 Willow Road, Menlo Park, Calif. 94025.

The VRU client 232 can also include an echo canceler (not shown) to reduce or cancel text-to-speech or playback echoes transmitted from the PSTN 214 due to hybrid impedance mismatches. The echo canceler is preferably included in an Antares Board Support Package, available from Dialogic.

The call control unit 236 of the communication node 212 is preferably connected to the LAN 240. The call control unit 236 sets up the telephone switch 230 to connect incoming calls to the VRU client 232. The call control unit also sets up incoming calls or pages into the node 212 over the internet 220 and pages and messages sent from the communication devices 201 and 203 via the paging network 203 and e-mail system 213. The control call unit 236 preferably comprises a computer, such as, a Window NT compatible computer.

The LAN 240 of the communication node 212 allows the various components and devices of the node 212 to communicate with each other via a twisted pair, a fiber optic cable, a coaxial cable, or the like. The LAN 240 may use Ethernet, Token Ring, or other suitable types of protocols. The LAN 240 is preferably a 100 Megabit per second Ethernet switch, available from Cisco Systems, San Jose, Calif. It will be recognized that the LAN 240 can comprise any suitable network system, and the communication node 212 may include a plurality of LANs.

The VRU server 234 of the communication node 212 is connected to the VRU client 232 and the LAN 240. The VRU server 234 receives speech communications from the user via the VRU client 232. The VRU server 234 processes the speech communications and compares the speech communications against a vocabulary or grammar stored in the database server unit 244 or a memory device. The VRU server 234 provides output signals, representing the result of the speech processing, to the LAN 240. The LAN 240 routes the output signal to the call control unit 236, the application server 242, and/or the voice browser 250. The communication node 212 then performs a specific function associated with the output signals.

The VRU server 234 preferably includes a text-to-speech (TTS) unit 252, an automatic speech recognition (ASR) unit 254, and a speech-to-text (STT) unit 256. The TTS unit 252 of the VRU server 234 receives textual data or information (i.e., e-mail, web pages, documents, files, etc.) from the application server unit 242, the database server unit 244, the call control unit 236, the gateway server 246, the application server 242, and the voice browser 250. The TTS unit 252 processes the textual data and converts the data to voice data or information.

The TTS unit 252 can provide data to the VRU client 232 which reads or plays the data to the user. For example, when the user requests information (i.e., news updates, stock information, traffic conditions, etc.), the communication node 212 retrieves the desired data (i.e., textual information) from a destination of the one or more of the information sources and converts the data via the TTS unit 252 into a response.

The response is then sent to the VRU client 232. The VRU client processes the response and reads an audio message to the user based upon the response. It is contemplated that the VRU server 234 can read the audio message to the user using human recorded speech or synthesized speech. The TTS unit 252 is preferably a TTS 2000 software package, available from Lernout and Hauspie Speech Product NV, 52 Third Avenue, Burlington, Mass. 01803.

The ASR unit 254 of the VRU server 234 provides speaker dependent or independent automatic speech recognition of speech inputs or communications from the user. It is contemplated that the ASR unit 254 can include speaker dependent speech recognition. The ASR unit 254 processes the speech inputs from the user to determine whether a word or a speech pattern matches any of the grammars or vocabulary stored in the database server unit 244 or downloaded from the voice browser. When the ASR unit 254 identifies a selected speech pattern of the speech inputs, the ASR unit 254 sends an output signal to implement the specific function associated with the recognized voice pattern. The ASR unit 254 is preferably a speaker independent speech recognition software package, Model No. RecServer, available from Nuance Communications. It is contemplated that the ASR unit 254 can be any suitable speech recognition unit to detect voice communications from a user.

The STT unit 256 of the VRU server 234 receives speech inputs or communications from the user and converts the speech inputs to textual information (i.e., a text message). The textual information can be sent or routed to the communication devices 201, 202, 203 and 204, the content providers 208 and 209, the markup language servers, the voice browser, and the application server 242. The STT unit 256 is preferably a Naturally Speaking software package, available from Dragon Systems, 320 Nevada Street, Newton, Mass. 02160-9803.

The VOIP unit 248 of the telecommunication node 212 is preferably connected to the telephone switch 230 and the LAN 240. The VOIP unit 248 allows a user to access the node 212 via the Internet 220 or VOIP public network using voice commands. The VOIP unit 240 can receive VOIP protocols (i.e., H.323 protocols) transmitted over the Internet 220 or intranet and can convert the VOIP protocols to speech information or data. The speech information can then be read to the user via the VRU client 232. The VOIP unit 248 can also receive speech inputs or communications from the user and convert the speech inputs to a VOIP protocol that can be transmitted over the Internet 220. The VOIP unit 248 is preferably a Voice Net software package, available from Dialogic Corporation. It will be recognized that the VOIP device can be incorporated into a communication device.

The telecommunication node 212 also includes a detection unit 260. The detection unit 260 is preferably a phrase or key word spotter unit to detect incoming audio inputs or communications or DTMF tones from the user. The detector unit 260 is preferably incorporated into the switch 230, but can be incorporated into the VRU client 232, the carrier switch 216, or the VRU server 256. The detection unit 260 is preferably included in a RecServer software package, available from Nuance Communications.

The detection unit 260 records the audio inputs from the user and compares the audio inputs to the vocabulary or grammar stored in the database server unit 244. The detector unit continuously monitors the user's audio inputs for a key phase or word after the user is connected to the node 212. When the key phrase or word is detected by the detection unit 260, the VRU client 232 plays a pre-recorded message to the user. The VRU client 232 then responds to the audio inputs provided by the user.

The billing server unit 238 of the communication node 212 is preferably connected to the LAN 240. The billing server unit 238 can record data about the use of the communication node by a user (i.e., length of calls, features accessed by the user, etc.). Upon completion of a call by a user, the call control unit 236 sends data to the billing server unit 238. The data can be subsequently processed by the billing server unit in order to prepare customer bills as described above. The billing server unit 238 can use the ANI or CLI of the communication device to properly bill the user. The billing server unit 238 preferably comprises a Windows NT compatible computer.

The gateway server unit 246 of the communication node 212 is preferably connected to the LAN 240 and the Internet 220. The gateway server unit 246 provides access to the content provider 208 and the markup language server 257 via the Internet 220. The gateway unit 246 also allows users to access the communication node 212 from the communication device 204 via the Internet 220. The gateway unit 246 can further function as a firewall to control access to the communication node 212 to authorized users. The gateway unit 246 is preferably a Cisco Router, available from Cisco Systems, San Jose, Calif.

The database server unit 244 of the communication node 212 is preferably connected to the LAN 240. The database server unit 244 preferably includes a plurality of storage areas to store data relating to users, speech vocabularies, dialogs, personalities, user entered data, and other information. Preferably, the database server unit 244 stores a personal file or address book as described above in reference to FIG. 3. The personal address book can contain information required for the operation of the system, including user reference numbers, personal access codes, personal account information, contact's addresses, and phone numbers, etc. The database server unit also stores user data, such as the user's home phone number, address, billing information, etc. The database server unit 244 is preferably a computer, such as an NT Window compatible computer.

The application server 242 of the communication node 212 is preferably connected to the LAN 240 and the content provider 209. The application server 242 allows the communication node 212 to access information from a destination of the information sources, such as the content providers and markup language servers. For example, the application server can retrieve information (i.e., weather reports, stock information, traffic reports, restaurants, flower shops, banks, calendars, “to-do” lists, e-commerce, etc.) from a destination of the information sources. This application server may include Starfish Software to provide the address book, calendar, and to-do lists and allow the user to organize information. The application server 242 processes the retrieved information and provides the information to the VRU server 234 and the voice browser 250. The VRU server 234 can provide an audio announcement to the user based upon the information using text-to-speech synthesizing or human recorded voice. The application server 242 can also send tasks or requests (i.e., transactional information) received from the user to the information sources (i.e., a request to place an order for a pizza). The application server 242 can further receive user inputs from the VRU server 234 based upon a speech recognition output. The application server is preferably a computer, such as an NT Windows compatible computer.

The voice markup language server 251 of the communication node 212 is preferably connected to the LAN 240. The markup language server 251 can include a database, scripts, and markup language documents or pages. The data markup language server 253 of the communication node 212 is also preferably connected to the LAN 240. The voice and date markup language servers 251 and 253 are preferably computers, such as an NT Window Compatible Computers. It will also be recognized that the markup language server 251 can be an Internet server (i.e., a Sun Microsystems server).

The messaging server 255 of the communication node 212 is preferably connected to the LAN 240, the paging network 211, an E-Mail system 285, and a short message system 290. The messaging server 255 routes pages between the LAN 240 and the paging network. The messaging server 255 is preferably a computer, such as an NT compatible computer. The message server can also provide email storage. It is contemplated that the messaging server 255 can reside externally from the node. The messaging server can further include Exchange Server software from Microsoft Corporation.

The voice browser 250 of the system 200 is preferably connected to the LAN 240. The voice browser 250 preferably receives information from the information sources, such as the content provider 209 via the application server 242, the data and voice markup language servers 251 and 257, the database 244, and the content provider 208, 209. In response to voice inputs from the user, out-of-band signaling, or DTMF tones, the voice browser 250 generates a content request (i.e., an electronic address) to navigate to a destination of one or more of the information sources. The content request can use at least a portion of a URL, an URN, an IP, a page request, or an electronic e-mail.

After the voice browser is connected to an information source, the voice browser preferably uses a TCP/IP connection to pass requests to the information source. The information source responds to the requests, sending at least a portion of the requested information, represented in electronic form, to the voice browser. The information can be stored in a database of the information source and can include text content, markup language document or pages, non-text content, dialogs, audio sample data, recognition grammars, etc. The voice browser then parses and interprets the information as further described below. It will be recognized that the voice browser can be integrated into the communication devices 201, 202, 203, and 204.

As shown in FIG. 9, the content provider 208 is connected to the application server 244 of the communication node 212, and the content provider 221 is connected to the gateway server 246 of the communication node 212 via the Internet 220. The content providers can store various content information, such as news, banking, v-commerce, e-commerce, weather, traffic conditions, etc. The content providers 208 and 221 can include a server to operate web pages or documents in the form of a markup language. The content providers 208 and 221 can also include a database, scripts, and/or markup language documents or pages. The scripts can include images, audio, grammars, computer programs, etc. The content providers execute suitable server software to send requested information to the voice browser.

The voice mail unit 274 of the telecommunication node 206 is preferably connected to the telephone switch 203 and the LAN 240. The voice mail unit 274 can store voice mail messages from users or other parties trying to send messages to users of the node. When a user accesses the telecommunication node 206, the voice mail unit 274 can notify the user of new and stored messages. The user can access the messages to play, delete, store and forward the messaged. When the user accesses a message, the message can be read to the user or can be displayed as textual information on a communication device (i.e., a paging unit, a SMS, or a PDA, etc.). The user can also access and operate external messages or mail systems remote from the telecommunication node 206.

The fax server unit 272 of the telecommunication node 206 is preferably connected to the telephone switch 230 and the LAN 240. The fax server unit 272 receivers and stores facsimile information sent via the electronic network 220 or the carrier switch 216. The users can access the facsimile information to play, store, delete, and forward the information. The facsimile information can be read to the user via the TTS unit 252 or can be displayed as textual information on a suitable communication device. The fax server unit 272 preferably comprises a computer such as, an NT compatible computer or a Dialogue Fax Server.

Further information regarding communication system 200 is disclosed in U.S. patent application Ser. No. 09/141,485 entitled Telecommunication System and Methods therefor, filed Aug. 27, 1998, the entire disclosure of which is incorporated herein.

It should be appreciated that the embodiments described above are to be considered in all respects only illustrative and not restrictive. The scope of the invention is indicated by the following claims rather than by the foregoing description. All changes which come within the meaning and range of equivalents of the claims are to be embraced within their scope.

I claim:

1. A method of providing caller information comprising the steps of:
providing a communication node in communication with an address book;
a first communication device having an associated number, the first communication device operatively connected to a transport system, the transport system operatively connected to the communication node;
inputting a subscriber number into the first communication device to place a call to a subscriber of the communication node;
routing the call through the transport system to the communication node;
determining if the number associated with the first communication device matches a stored number in the address book; and
delivering a name associated with the stored number to a second communication device to provide the name of the caller to the subscriber.

2. The method of claim 1 further comprising the step of delivering a location associated with the stored number to the second communication device to provide the location of the caller to the subscriber.

3. The method of claim 1 wherein the transport system is one of a Public Switched Telephone Network, a cellular network, a satellite system, and a VOIP network.

4. The method of claim 1 wherein at least one of the first and second communication device includes one of a telephone, a satellite phone, a paging unit, and a cellular phone.

5. The method of claim 1 further comprising the step of bypassing a caller identification block placed by the caller.

6. The method of claim 1 further comprising the step of providing the name of the caller to a third communication device of the subscriber.

7. The method of claim 6 further comprising the step of routing the call to the second communication device in response to commands received via the third communication device.

8. The method of claim 1 wherein a short message service (SMS) is delivered to the second communication device to provide at least one of the name and location associated with the stored number to the subscriber.

9. The method of claim 1 wherein an audible signal is delivered to the second communication device to provide the name associated with the stored number to the subscriber.

10. The method of claim 1 further comprising the step of sending a signal from the second communication device to the communication node to instruct the communication node on placement of the call.

11. The method of claim 10 wherein the signal from the second communication device to the communication node instructs the communication node to send the call into voicemail.

12. The method of claim 10 wherein the signal from the second communication device to the communication node instructs the communication node to complete the call.

13. The method of claim 1 further comprising the step of determining the subscriber based on the subscriber number.

14. The method of claim 1 further comprising the step of directing the communication node to access a remote database to identify at least one of a name and location of the caller.

15. A system for providing caller identification comprising:
a communication node having at least one incoming line and at least one outgoing line, the communication node being responsive to at least one control signal to route an incoming call received from a caller to a called party;
computer readable program code that determines if the number associated with the incoming call matches a stored number in a database of the communication node; and
computer readable program code that delivers at least one of a location and a name associated with the stored number to the at least one outgoing line to provide the name of the caller to the called party.

16. The system of claim 15 further comprising:
computer readable program code that directs the communication node to access a remote database to identify at least one of a name and location of the caller.

17. A program stored in a communication system for providing caller information comprising:
computer readable program code to determine if a number associated with an incoming call matches a stored number in an address book; and
computer readable program code to deliver at least one of a location and name associated with the stored number to a called party.

18. The program of claim 17 wherein the address book is remote from the communication node.

19. A method of providing caller information comprising the steps of:
receiving an incoming call from a first number;
determining the phone number of the incoming call;
placing a second call to a party at a second number, different than the first number;
connecting the second call with the incoming call; and
providing the first number of the incoming call to the party at the second number.

20. The method of claim 19 further comprising the step of determining at least one of a name and a location of the caller by comparing the phone number to a list of names in a database.

21. The method of claim 20 further comprising the step of providing at least one of the name and location of the caller to the called party.

22. A method of providing caller identification comprising the steps of:
receiving an incoming call from a calling party destined for a subscriber;
determining the number of the incoming call;
comparing the number of the incoming call to a list of contacts for the subscriber;
determining at least one of a name and location of the calling party;
establishing a connection between the subscriber and the called party;
notifying the subscriber of at least one of the name and location of the calling party;
linking the caller and the called party in response to commands from the called party so that the caller can communicate with the called party.

23. A method of providing caller identification comprising the steps of:
receiving an incoming call from a calling party destined for a subscriber;
determining the number of the incoming call;
comparing the number of the incoming call to a list of contacts for the subscriber;
determining at least one of a name and location of the calling party;
providing the at least one of the name and location of the calling party to the subscriber; and
routing the incoming call to the subscriber.

24. A method of providing caller identification comprising the steps of:
receiving an incoming call from a calling party destined for a subscriber;
determining the number of the incoming call;
comparing the number of the incoming call to a list of contacts for the subscriber;
determining at least one of a name and location of the calling party;
notifying the subscriber of the name and location of the calling party;
determining whether the subscriber desires to receive the incoming call based upon commands from the subscriber; and
routing the incoming call to the subscriber.

25. A method of providing caller identification comprising the steps of:
receiving an incoming call from a calling party destined for a subscriber;
determining the number of the incoming call;
comparing the number of the incoming call to a list of contacts for the subscriber;
determining at least one of a name and location of the calling party;
determining from a database whether to route the call to the subscriber;
providing the at least one of the name and location of the calling party to the subscriber.
